(19) United States
(12) Patent Application Publication
(10) Pub. No.: US 2008/0277016 A1
(43) Pub. Date: Nov. 13, 2008

(54) EXHAUST TUBE INTERFACE FOR AN EXHAUST TREATMENT DEVICE

(76) Inventors: Robertus W. Covers, Swartz Creek, MI (US); Theodore R. Turner, JR., Grand Blanc, MI (US)

Correspondence Address: DELPHI TECHNOLOGIES, INC., M/C 480-410-202, PO BOX 5052, TROY, MI, 48007, US

(21) Appl. No.: 11/746,473

(22) Filed: May 9, 2007

(51) Int. Cl. F16L 9/22

(52) U.S. Cl. 138/155

(57) ABSTRACT

An interface for connecting a transition pipe of an exhaust producing device to a housing of an exhaust treatment device, comprising: a generally spherical structure having a truncated first end and a second end, the truncated first end having an orbicular opening; and a conduit structure having a first end and a second end, the first end of the conduit structure having a generally spherically flared orbicular opening, an inner surface of the conduit structure proximate to the flared orbicular opening of the first end of the conduit structure being secured to an exterior surface of the generally spherical structure proximate to the orbicular opening of the truncated first end to form a fluid passageway through the conduit structure and the generally spherical structure, the truncated first end of the generally spherically structure and the generally spherically flared orbicular opening of the conduit structure each allowing the conduit structure to be angularly offset from a lateral axis through the exhaust treatment device.

### BACKGROUND

Exemplary embodiments of the present invention generally relate to exhaust treatment devices. More particularly, exemplary embodiments of the present invention relate to the interface coupled between an exhaust treatment device and an exhaust tube.

An internal combustion engine, such as for a motor vehicle, is generally required to have some form of exhaust aftertreatment device to combust and/or reduce exhaust gas constituents generated during a combustion process. An exhaust aftertreatment device, such as a catalytic converter, operates to reduce the toxicity of exhaust emissions as they pass through by providing an environment for a chemical reaction involving catalysts, wherein toxic combustion byproducts are converted to less-toxic gases prior to their escape into the atmosphere. The catalysts serve to catalyze, for example, the oxidation of carbon monoxide to carbon dioxide, the oxidation of hydrocarbons to carbon dioxide and water, and the reduction of nitrogen oxides to nitrogen and oxygen. Such devices have utility in a number of fields, including the treatment of exhaust gas streams from automobiles, trucks, and other devices having internal combustion engines.

Typical catalytic converters can include a housing comprising an insulated shell to which end cone assemblies are welded for connecting the larger main body of the converter housing to associated exhaust tubes that carry exhaust from an internal combustion engine or other components. A catalytic element can be assembled into the shell prior to installing and welding the end cone assemblies on to the shell. The shell may have a circular cross section or be one of a multitude of suitable non-circular configurations, including oval, and rounded triangular and trapezoidal shapes.

The catalytic converter shell may comprise an inlet opening and an outlet opening for exhaust gas. The exhaust tube of an internal combustion engine provides a conduit for exhaust gas emitted from the combustion chambers in the engine to the catalytic converter inlet. The exhaust tube can be inserted into and welded together with the converter opening to secure a gas tight seal between the exhaust tube and catalytic converter. Because a catalytic converter can be larger in diameter than the exhaust system into which it is placed, the catalytic converter can include flow transition devices that are often referred to as end cones. One of the chief functions of the end cones is to transition the diameter from the exhaust inlet and outlet pipes to the diameter of the converter housing openings and to evenly distribute the exhaust gas within a catalytic converter and over the face of a catalyst.

End cone assemblies are typically installed on both ends of a catalytic converter shell following the installation of a wrapped catalytic element within the shell. End cones are generally formed using a sheet metal forming process involving considerable time and expense, in which a new set of transfer dies is required for the production of each cone. Previously, when a larger or smaller converter shell opening had to connect with larger or smaller exhaust pipes, the assembly was required to be designed with entirely new end cones. Additionally, while catalytic converter inlet and outlet openings are often straight and on-center, they also can be manufactured at an angle. These circumstances generally call for provision of two new sets of dies, one for each cone, and a complete change out of all the dies whenever a production change between opening cone assemblies was required.

Because specific catalytic converters are often used for multiple vehicle and engine combinations, and because the tooling to manufacture end cones with openings of varying sizes and angles is very expensive, design variations required to accommodate different end fitting interfaces can add considerable cost to the manufacturing process, as well as a considerable risk of imperfections.

A typical catalytic converter has end cones that are shaped to form the transition between the exhaust tubes and the larger main body of the converter housing. The main body of the catalytic converter holds a catalyst element with its support and insulation materials.

On the inlet side for example, a typical exhaust tube is inserted into the converter inlet opening and welded together to form a leak free joint between the exhaust tube and the catalytic converter.

The exhaust tubes are sized to fit tightly into the converter openings. The converter inlet and outlet openings are also called snorkels. For automotive applications most exhaust tubes have a round cross-section with an outside diameter in the range of about 50-80 mm and are inserted into the catalytic converter with an insertion depth in the range of 5-25 mm.

The end cones can be constructed as sheet metal stampings or is integral part of the shell that forms the converter housing. The cross-sectional size of a typical automotive catalytic converter housings are in a range of about 75-300 mm, with most housings in the range of 100-150 mm. There is a multitude of cross-sectional housing shapes including round, oval and rounded triangular and trapezoidal shapes. The catalytic converter inlet and outlet openings are sometimes straight and on-center, but other times at an angle. A specific catalytic converter body is used for multiple vehicle and engine combinations. This results in design variations to accommodate different and fitting interfaces. The tooling to create end cones with varying snorkel sizes and snorkel angles is highly capital intensive.

Accordingly, it is desirable to provide an improved interface at the junction between a catalytic converter body and an exhaust pipe. In addition, it is also desirable to provide an interface that is suitable for use in a variety of designs and configurations of exhaust treatment devices.

### SUMMARY OF THE INVENTION

Exemplary embodiments of the present invention relate to an interface for connecting a transition pipe of an exhaust producing device to a housing of an exhaust treatment device in accordance with an exemplary embodiment is provided. The interface includes a generally spherical structure having a truncated first end and a second end, and a conduit structure having a first end and a second end. The truncated first end has an orbicular opening. The first end of the conduit structure has a generally spherically flared orbicular opening. An inner surface of the conduit structure proximate to the flared orbicular opening of the first end of the conduit structure is secured to an exterior surface of the generally spherical structure proximate to the orbicular opening of the truncated first end to form a fluid passageway through the conduit structure and the generally spherical structure. The truncated first end of the generally spherically structure and the generally spherically flared orbicular opening of the conduit structure each allow the conduit structure to be angularly offset from a lateral axis through the exhaust treatment device.

Exemplary embodiments of the present invention also relate to a method for providing interfaces for fluid paths through an exhaust treatment device, the method comprising: forming a first end cone with a generally spherical wall portion; forming a second end cone with a generally spherical wall portion, the generally spherical wall portion of the first end cone being substantially similar to the generally spherical wall portion of the second end cone; providing an orbicular opening in the generally spherical wall of the first end cone, the first end cone having an inlet end, an outlet end, the generally spherical wall being truncated at the inlet end proximate to the orbicular opening; providing an orbicular opening in the generally spherical wall of the second end cone, the second end cone having an inlet end, an outlet end, the generally spherical wall being truncated at the inlet end proximate to the orbicular opening; securing an inner surface of a flared opening of a first exhaust conduit to an exterior surface of the generally spherical wall of the first end cone proximate to the orbicular opening to form a first fluid passageway through the first exhaust conduit and the first end cone; securing an inner surface of a flared opening of a second exhaust conduit to an exterior surface of the generally spherical wall of the second end cone proximate to the orbicular opening to form a second fluid passageway through the second exhaust conduit and the second end cone; securing the outlet end of the first end cone to one end of a housing of the exhaust treatment device; and securing the outlet end of the second end cone to another end of the housing.

In another exemplary embodiment a method for providing an interface between a housing of an exhaust treatment device and a conduit is provided, the method comprising: forming a first end cone with a generally spherical wall; providing an orbicular opening in the generally spherical wall; securing an inner surface of a flared opening of the conduit to an exterior surface of the generally spherical wall proximate to the orbicular opening to provide the interface, the configuration of the generally spherical wall allowing the interface to be at numerous locations without requiring a change in the curvature of the generally spherical wall.

Exemplary embodiments of the present invention also relate to an exhaust assembly for directing a flow of exhaust emissions from an exhaust producing device through an exhaust treatment device. The exhaust assembly comprises an exhaust pipe, an end cone assembly, and a housing of the exhaust treatment device. The exhaust pipe has an inner surface, an inlet end, and an outlet end having a flared orbicular opening. The end cone assembly has a cone inlet end, a cone outlet end, and a generally spherical wall truncated at the cone inlet end to form an orbicular opening. An exterior surface of the generally spherical wall proximate to the orbicular opening at the cone inlet end is secured to the inner surface of the exhaust pipe proximate to the flared orbicular opening of the pipe outlet end to form a fluid passageway through the exhaust pipe and the end cone assembly. The truncated end of the generally spherically wall and the flared orbicular opening of the exhaust pipe each allow the exhaust pipe to be angularly offset from a lateral axis extending through the exhaust treatment device. A housing of the exhaust treatment device having an inlet end connected secured to the cone outlet end of the end cone assembly.

Exemplary embodiments of the present invention also relate to an end cone assembly for coupling a conduit structure to an exhaust treatment device. The end cone assembly comprises an inner wall having a first end and a second end, an outer wall having a first end and a second end, and an insulating layer. The first end of the outer wall is coupled to the inner wall proximate to the first end of the inner wall. An outer surface of the outer wall proximate the first end of the outer wall is of a generally arcuate shape to engage an interior surface of a flared wall of the conduit structure to define a fluid flow path through the conduit structure and the end cone assembly. The second end of the outer wall is configured to engage a housing of the exhaust treatment device. The second end of the outer wall is spaced away from the second end of the inner wall so as to define an inner region therebetween. The insulating layer is disposed within the inner region between a portion of the outer wall and a portion of the inner wall. The generally arcuate shape of the first end of the outer wall and the interior surface of the flared wall of the conduit structure allows the conduit structure to be angularly offset from a lateral axis extending through the exhaust treatment device.

### BRIEF DESCRIPTION OF THE DRAWINGS

FIG. 1 is a transverse cross-sectional view showing the construction of an exemplary exhaust tube end constructed in accordance with exemplary embodiments of the present invention;

FIG. 2 is transverse cross-sectional view showing the internal construction of an exemplary exhaust tube/end cone assembly interface constructed in accordance with exemplary embodiments the present invention;

FIG. 3 is transverse cross-sectional view showing the internal construction of an alternative exemplary exhaust tube/end cone assembly interface constructed in accordance with exemplary embodiments the present invention;

FIG. 4 is a side view showing the external construction of an exemplary exhaust tube/end cone assembly interface and a catalytic converter shell constructed in accordance with exemplary embodiments the present invention;

FIG. 5 is a transverse cross-sectional view showing the internal construction of an exemplary end cone assembly and exhaust tube/end cone assembly interface constructed in accordance with exemplary embodiments the present invention; and

FIG. 6 is a side view showing the external construction of an exemplary exhaust tube/end cone interface and a catalytic converter shell constructed in accordance with exemplary embodiments the present invention.

### DETAILED DESCRIPTION OF EXEMPLARY EMBODIMENTS

Exemplary embodiments of the present invention illustrated in the attached drawings and described in the following specification relate to the incorporation of a spherical interface at the junction between an internal combustion engine's exhaust tubes and the end cones of a catalytic converter. The description herein relates to exemplary embodiments illustrated in the attached drawings, but it is to be understood that the present invention is not limited to the specific embodiments disclosed herein and may assume various alternative orientations. The specific devices and processes illustrated in the attached drawings, and described in the following specification, are simply exemplary embodiments of the inventive concepts disclosed herein. Hence, specific dimensions and other physical characteristics relating to the embodiments disclosed herein are not considered to be limiting.

In accordance with exemplary embodiments of the present invention, the exhaust tubes and end cones are designed to have a spherical geometry at the interface. Instead of inserting the exhaust tube to make the connection to the catalytic converter body, the exhaust tubes are placed on the exterior of the end cones. In an exemplary embodiment, the interface detail on the end cone surface would be shaped as a sphere with a round opening to allow gas flow. The mating exhaust tube would be flared open to a spherical geometry to mate with the spherical end cone surface. The connection can be secured, for example, with a fillet weld at the edge of the spherical flare of the tube and the end cone surface.

One advantage of the interface design is the flexibility to accommodate a wider range of design variations with one set of end cone tooling. For example, without modifying the end cone design, tubes with different diameters can be used.

In accordance with an exemplary embodiment and if a modification in the snorkel opening is required, the tooling to form the end cone can be shared. Only different trim die details would be required to form the variations of the snorkel opening diameter.

In addition and in an exemplary embodiment, the snorkel opening can be trimmed into the end cone at a modified angle. This concept allows for the possibility to share the end cone forming tooling for different snorkel angle variations. Accordingly, a wide range of snorkel angles can be accomplished by varying the location of the snorkel piercing operation. This will allow a wide range of entry and exit angles for the catalytic converter design with the same fabrication tooling.

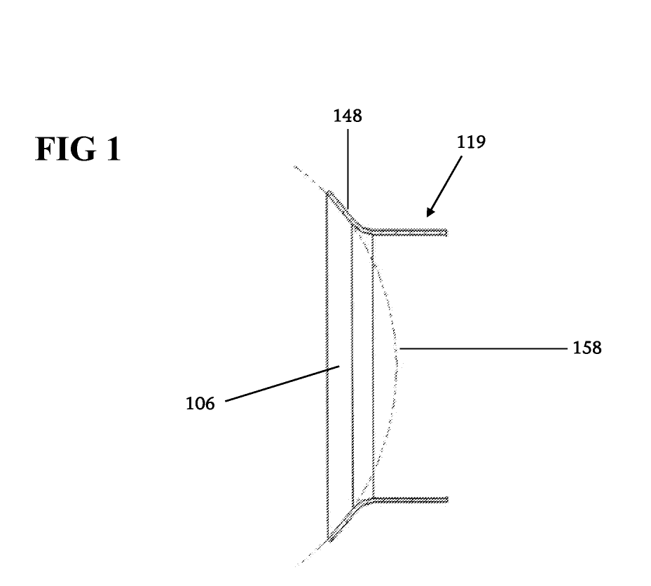

Referring now to FIG. 1, a cross-sectional view of an exemplary embodiment of an inlet or outlet end 106 of a conduit or pipe 119 is illustrated. Conduit 119 is generally cylindrical and flares radially outward at end 106 to form a large annulus at a generally spherical flare 148 that is configured to be connected with the exterior surface of a component having a generally spherical geometry. In FIG. 1, a partial cross-section of generally spherical component, depicted as broken-line 158, is shown placed against end 106 of conduit 119. A circumferential weld, for example, may extend around the exterior surface of the spherical component and the interior surface of flare 148 to form an airtight seal for preventing gas leakage.

In accordance with an exemplary embodiment of the present invention, the component having a generally spherical geometry is formed by a suitable manufacturing process and thereafter an opening is formed therein using a piercing, stamping, or other suitable method that allows the opening to be located in numerous locations of the spherical component, thus providing many angular configurations in which the conduit can be secured to the spherical component without requiring the need for new tooling to form the spherical component. Non-limiting examples of the material or sheet metal used for the end cone assembly and conduits of exemplary embodiments of the present invention can include steel, stainless steel, and equivalents alloys thereof (e.g., Stainless Steel 409, Stainless Steel 439, ULTRA FORM Stainless Steel currently available from AK Steel, etc.). Of course, other suitable materials are contemplated for use in exemplary embodiments of the present invention.

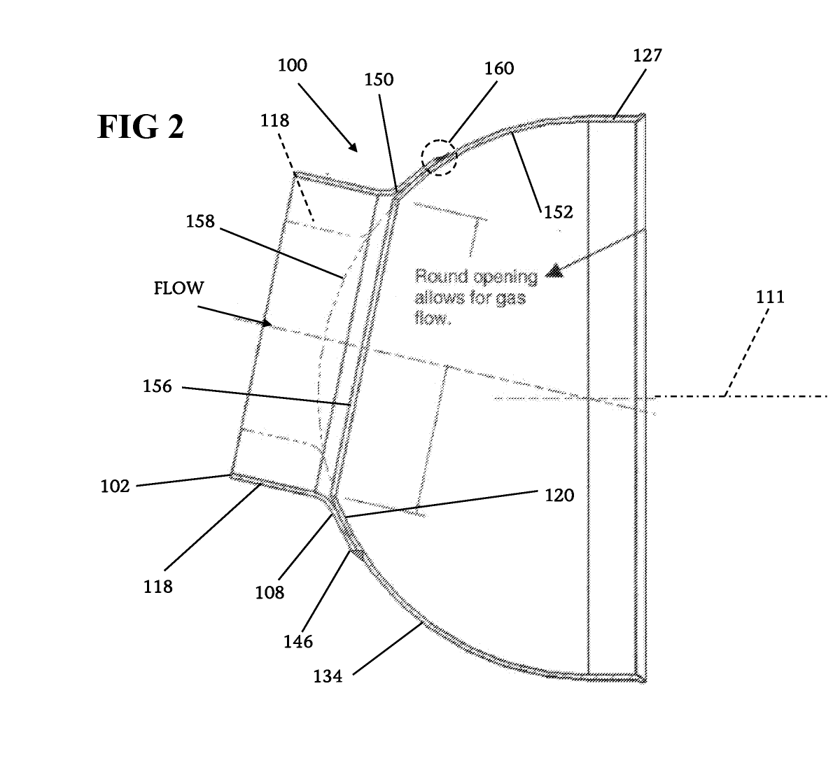

Referring now to FIG. 2, an exemplary embodiment of an exhaust tube/end cone assembly interface 100 in accordance with the present invention is illustrated. As shown, an outlet or inlet end 108 of a conduit or pipe 118 is connected with an outlet or inlet end 120 of a generally spherical outer wall 134, which also has a second outlet or inlet end 127. Outer wall 134 is truncated, stamped, pierced, or cut at end 120 to form an annular opening 156 to allow gas flow to or from conduit 118. Broken line 158 depicts where the periphery of generally spherical outer wall 134 would extend were it not truncated at end 120. Also, dashed line 118a illustrates an example of a smaller diameter conduit or exhaust tube that can be used in alternative exemplary embodiments without any modification of outer wall 134 of the present exemplary embodiment other than perhaps providing a smaller opening. Conduit 118 is generally cylindrical and flares radially outward at end 108 to form a generally spherical flare 146. A circumferential weld 160 (e.g., fillet weld or other equivalent welds) extends around an inner surface 150 of flare 146 of conduit 118 and an exterior surface 152 of outer wall 134 at end 120 to form an airtight seal at interface 100 preventing gas leakage. In accordance with exemplary embodiments, weld 160 may be formed by any suitable welding process. In exemplary embodiments, non-limiting welds include but are not limited to arc welds, friction/inertia welds, rotated drawn arc welding, flash/forge welding, tack welds, metal inert gas (MIG) welds, TIG welds, laser welds, or equivalents thereof.

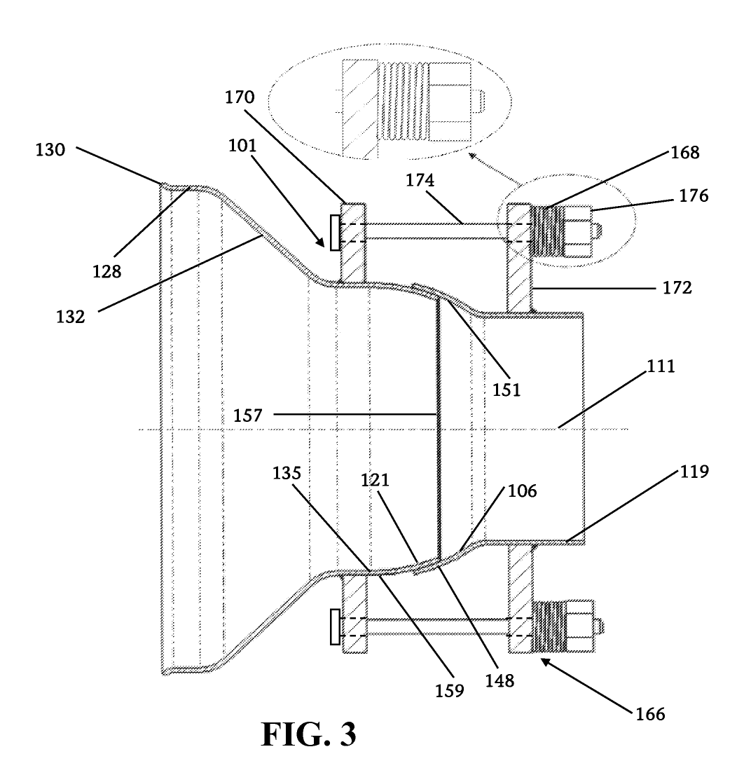

Referring now to FIG. 3, an alternative exemplary embodiment of an exhaust tube/end cone assembly interface 101 in accordance with an exemplary embodiment of the present invention is illustrated. As shown, an inlet or outlet end 106 of a conduit or pipe 119 is connected with an inlet or outlet end 121 of a generally spherical outer wall 135. Outer wall 135 is truncated at end 121 to form an annular opening 157 to allow gas flow to or from conduit 119. Conduit 119 is generally cylindrical and flares radially outward at end 106 to form a generally spherical flare 148.

In the present exemplary embodiment, interface 101 is further configured to connect with an end of a complimentary component, such as, for example, a catalytic converter shell, having a suitable circular or non-circular configuration such as, for example, oval, and rounded triangular and trapezoidal shapes. To make such a connection, spherical outer wall 135 connects with a generally conical outer wall 132 that tapers outward to connect with an outer large end 128 opposing end 121. Outer large end 128 is generally cylindrical and configured to slide over an end of the complimentary configured component. A slight outward flare 130 is provided at the free edge of outer large end 128 to assist the installation.

In the present exemplary embodiment, interface 101 further comprises a flex joint 166 having compression springs 168 to flexibly and sealingly interconnect an inner surface 151 of flare 148 of conduit 119 and an exterior surface 159 of outer wall 135 at end 121, wherein the two surfaces are secured together without the need for a weld. As illustrated, the flex joint comprises a pair of flanges 170 and 172 each secured (e.g., welded, cold formed, etc.) to a respective portion of the exhaust conduit or end cone assembly of the interface. Flanges 170 and 172 are each configured to receive a bolt or stud 174, wherein a nut 176 engages a threaded portion of the bolt to compress springs 168 between the nut and a surface of the flange 172. It should be noted, of course, that FIG. 3 illustrates a non-limiting exemplary embodiment. It is contemplated that, in exemplary embodiments, other securement methods may be employed, such as, for example, integrally molding bolt 174 with flange 170.

To enhance the flexibility and sealing of interface 100, flex joint 166 can deflect and permit relative rotational movement at the overlap between the sealed surfaces of outer wall 135 and flare 148 of conduit 119 to absorb dynamic movement in exhaust systems caused by simple operational functions like turning an engine on or braking hard. For example, the conduit and the end cone assembly may tilt relative to one another. Thus, flex joint 166 can be provided to increase the ability of the seal at interface 101 to withstand many operational stresses such as, for example, thermal expansion, exposure to water, system movement such as vibrations and engine torque, and the corrosive elements in different types of exhaust. In exemplary embodiments, flex joint 166 may further comprise a wire mesh gasket.

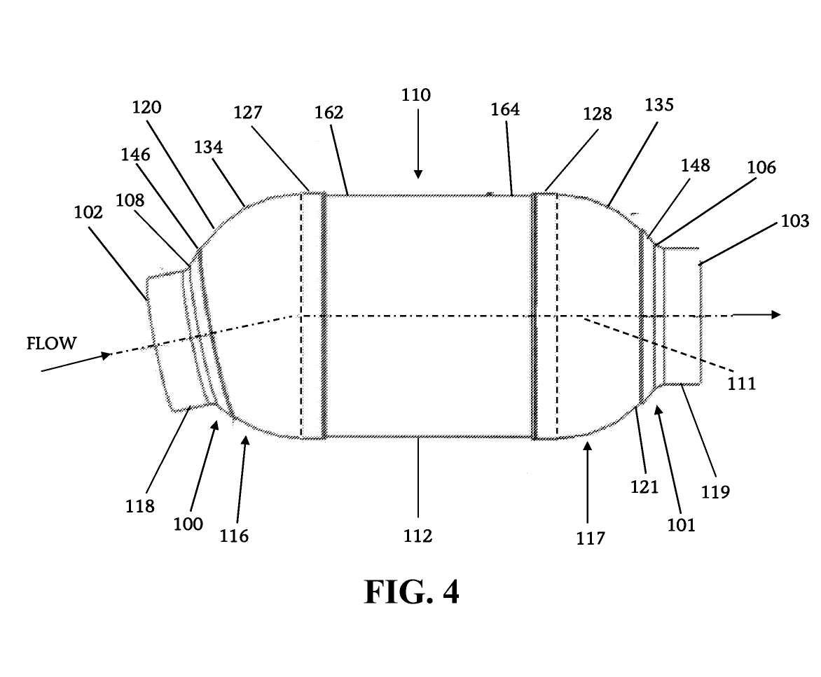

In non-limiting exemplary embodiments or assemblies utilizing exemplary exhaust tube/end cone assembly interfaces in accordance with the present invention, such as the exemplary embodiments illustrated in FIGS. 4-6 and described below, inlet or outlet conduits, such as conduit 118 or conduit 119, can connect with an exhaust tube or pipe, and generally spherical outer walls, such as outer wall 134 or outer wall 135, can connect with an end cone assembly. For instance, inlet or outlet end 102 of conduit 118 can be configured to connect with or can be integrally formed with an exhaust pipe. Thus, it should be noted that, in exemplary embodiments inlet or outlet conduits, such as conduit 118 or conduit 119, can comprise exhaust pipes and/or have a longer length than shown in the exemplary embodiments illustrated in the Figures.

Referring now to FIG. 4, a side view of the external construction of an exemplary embodiment of a catalytic converter assembly 110 utilizing a pair of exhaust tube/end cone assembly interfaces in accordance with exemplary interface 100 illustrated in FIG. 2 is shown. Exemplary assembly 110 of FIG. 4 includes a generally cylindrical housing or shell 112. Shell 112 has an exhaust inlet end 162 and an exhaust outlet end 164, and is connected at both ends with coaxial spherical end cone assemblies 116, 117. The end cone assemblies include generally spherical outer walls 134, 135 that extend between and are truncated at small ends 120, 121 and large ends 127, 128 respectively. Large ends 127, 128 are welded to opposing ends of shell 112 to hold end cone assemblies 116, 117 in place and seal the joints against gas leakage.

In the present exemplary embodiment, end cone assembly 116 is engaged with and circumferentially welded to a generally spherical outlet flare 146 proximate to an outlet end 108 of an inlet conduit or pipe 118 at interface 100, and coaxial end cone assembly 117 is engaged with and circumferentially welded to a generally spherical inlet flare 148 proximate to an inlet end 106 of inlet conduit or pipe 119 at interface 101, to form airtight seals for preventing gas leakage. As indicated in FIG. 4, inlet conduit 118 has an inlet end 102 that can be configured to connect with or is integrally formed with an exhaust pipe, and outlet conduit 119 has an outlet end 103 that can be configured to connect with or is integrally formed with an exhaust pipe. In an exemplary embodiment, inlet and outlet conduits 118, 119 can be integrally formed as a one-piece component with inlet and outlet exhaust tubes carrying exhaust gas flow to and from catalytic converter assembly 110 in an internal combustion engine.

In the exemplary embodiment illustrated in FIG. 4, an annular inlet opening (not shown) is disposed at a different angle on the perimeter of generally spherical outer wall 134 than the angle at which an annular outlet opening (not shown) is disposed on the perimeter of generally spherical outer wall 135. This modification permits end cone assemblies 116, 117 to remain coaxial while still interfacing with conduits 118, 119 that, as shown in FIG. 4, are disposed at discrepant inlet and outlet angles. In other words, the conduits may be angularly offset from a lateral axis 111 through the housing and/or orbicular openings of the spherical outer walls (see at least FIGS. 3-6). In other words, the corresponding opening of one of the spherical outer wall members can be offset from the housing while the other is aligned with the lateral axis. As illustrated in FIG. 4, while spherical outer walls 134 and 135 are provided with generally the same shape, the opening in wall 134 is positioned to interconnect with conduit 118 at an offset angular configuration. In another alternative exemplary configuration, slight movements or arrangements of the conduit with respect to the opening in the spherical outer walls are also possible due to the flared opening of the conduit. In addition, in yet more alternative exemplary configurations, the diameter or peripheral opening in the spherical outer wall can be increased or reduced to provide design flexibility as well as movement of the conduit with respect to the outer surface of the spherical wall.

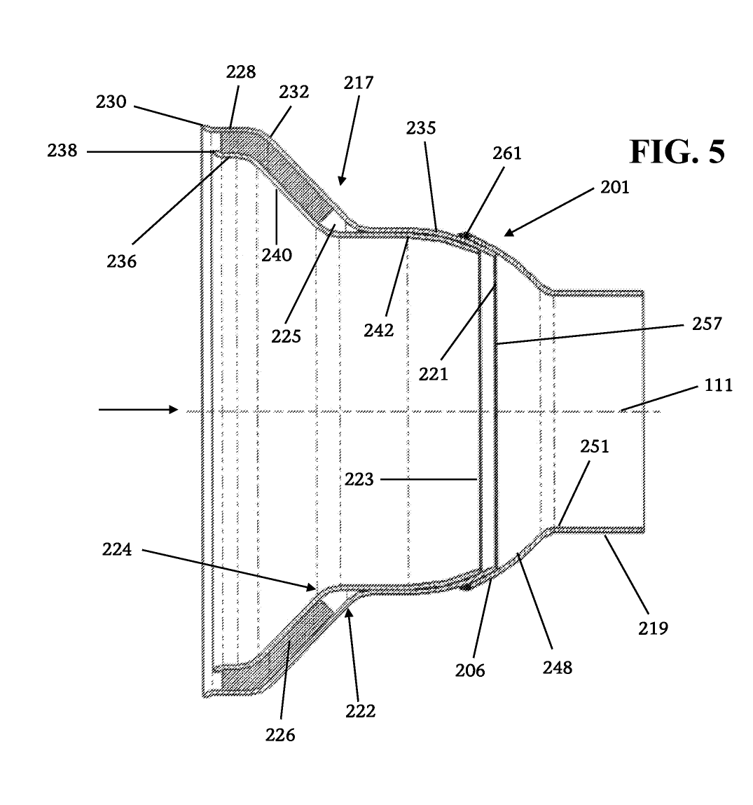

In accordance with another exemplary embodiment of the present invention, FIG. 5 illustrates a cross-sectional view of an interface 201 between an exhaust conduit or pipe 219 interfaced with a dual wall end cone assembly 217 that is configured to connect with an end of a catalytic converter shell having a complementary circular or non-circular configuration such as, for example, oval, and rounded triangular and trapezoidal shapes. The exemplary embodiment of FIG. 5 shows a spherical external interface concept configured with an insulated end cone design while FIG. 3, utilizing a flex joint to provide for sealing the interface, shows the same with the standard non-insulated end cone configuration.

End cone assembly 217 has a formed sheet metal outer wall 222 and a smaller formed sheet metal inner wall 224 to form a dual wall assembly. An insulating air gap 225 is formed between portions of outer and inner walls 222, 224 to thermally insulate the space therebetween to improve the performance of an associated catalytic converter. Additionally, a fibrous insulating pad or layer 226 is disposed within air gap 225 to provide further insulation. In exemplary embodiments, other forms of high temperature insulation may also be used. Layer 226 is preferably installed on inner wall 224 prior to inserting the inner wall into outer wall 222 to form the dual wall assembly.

Outer wall 222 comprises a generally conical outer wall portion 232 that tapers inward to connect with a generally spherical outer wall portion 235, inner wall 224 comprises a generally conical inner wall portion 240 that tapers inward to connect with a generally spherical inner wall portion 242. Spherical inner wall portion 242 is sized to fit closely within and engage spherical outer wall portion 235. The outer surface of spherical inner wall portion 242 and the interior surface of spherical outer wall portion 235 are interconnected by suitable means, such as welding or the like. As illustrated, conical outer wall portion 232 connects with an outer large end 228, and conical inner wall portion 240 connects with an inner large end 236.

In the present exemplary embodiment, end cone assembly 217 is suitably designed for connection with an end of a catalytic converter shell having a complimentary configuration. To make such a connection, outer large end 228 is generally cylindrical and configured to slide over one end of a complimentary converter shell, and inner large end 236 generally cylindrical and sized to fit within the same end of the converter shell. A slight outward flare 230 is provided at the free edge of outer large end 228 to assist the installation, and a slight outward flare 238 at the free edge of inner large end 236 engages the shell upon installation.

As illustrated in FIG. 5, outer wall portion 235 and inner wall portion 242 are truncated at respective inlet or outlet ends 221, 223 to form an annular opening 257. Conduit 219 has an inner surface 251 and a generally spherical flare 248 at an inlet or outlet end 206. A circumferential weld 261 extends around inner surface 251 of conduit 219 at generally spherical flare 248 of end 206 and the exterior surface of outer wall portion 235 at end 221 to connect finished end cone assembly 217 with conduit 219 and form an airtight seal for preventing gas leakage.

As will now be described, in exemplary embodiments of the present invention, the angles of the inlet and outlet openings are permitted to vary in end cone assemblies to provide for flexibility to accommodate a wider range of exhaust design variants without requiring modification of the end cone design. In addition, exemplary embodiments allow for the diameters of the inlet and outlet openings to be varied to accommodate conduits of varying diameters. Exemplary embodiments can also involve end cone assemblies that are configured with inner ends and conical wall portions to accommodate catalytic converter shells of a multitude of suitable circular or non-circular configurations, including oval, and rounded triangular and trapezoidal shapes. In these exemplary embodiments, only the outer ends of the end cones include generally spherical outer wall portions.

In exemplary embodiments, end cone snorkels having generally spherical wall portions can be manufactured using a more favorable process in which the generally spherical wall portion is formed, using, for example, deep drawing and/or metal stamping technology such that the orbicular opening is merely stamped, cut, or pierced into the formed wall. During the metal stamping process, the end cone snorkel is formed by cutting a flat stock sheet metal into a blank, and then forming the blank into a desired shape in a stamping press. In exemplary embodiments, the sheet metal can comprise, for instance, stainless steels and other high-strength alloys. In the metal stamping process, dies, press tools consisting of specially designed cavities, are used to shape and cut metal parts from the inserted sheet metal.

During press operation, slides, or rams, maintain movement to and from corresponding motionless press beds, each of which has an appropriately sized cavity. The upper component of the die connects to the press slide, and the lower component connects to the press bed. A die component called the punch performs the necessary shaping operation by pushing the sheet metal through the die. As is typical when forming end cone snorkels, the forming of end cone snorkels in exemplary embodiments of the present invention can involve progressive die stamping in which several dies are used sequentially on the same piece of sheet metal at a series of forming stations to linearly form the end cone snorkel. For each station, the die geometry, drawing depth, and pushing force can vary. As the metal blank is formed, it is displaced through the bend radius. The material on the inside of the bend is compressed, while the material on the outside of the bend is stretched.

In exemplary embodiments, after forming the metal blank into the desired snorkel shape (e.g., a dome, a cup, or an end cone having a generally spherical wall portion), metal stamping can used to form a slug in the neck end of the work piece and then pierce the work piece to remove the slug to form an orbicular snorkel opening of predetermined size and at a predetermined location. Following piercing, the neck of the snorkel is extruded into a final shape that is configured to engage an exhaust tube. This is the most challenging part of the forming process because the features placed at the outer end of a form are those which are most greatly affected by the angular tolerance of the bend and the distance from the bend. In exemplary embodiments of the present invention, however, the outer ends of end cone snorkels being formed into generally spherical wall portions are less susceptible to cracking or splitting during this forming than the outer ends of typical end cone assemblies. Moreover, the generally spherical wall portions are less susceptible to wear and tear or splitting than typical end cone assemblies.

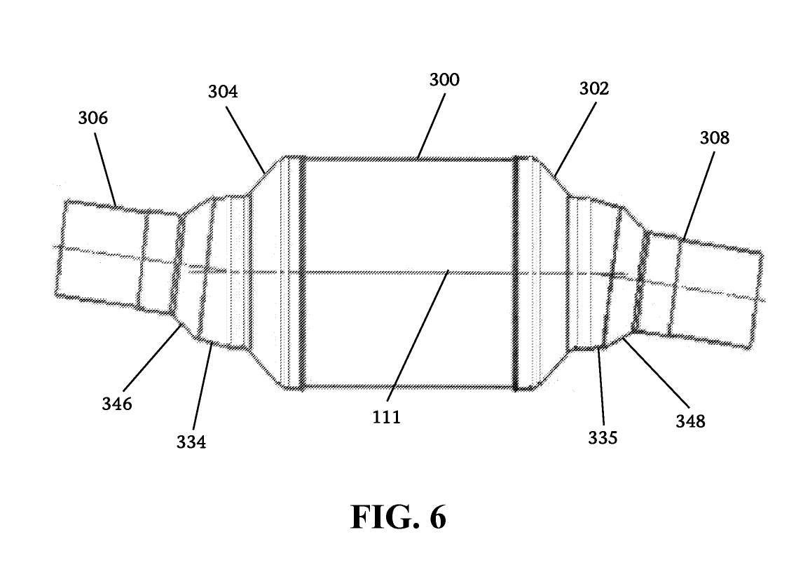

Referring now to the alternative exemplary embodiment depicted in FIG. 6, a side view of the external construction of a catalytic converter assembly having a housing 300 connected at both ends with straight, coaxial end cone assemblies 302, 304 of the type illustrated in, for example, the exemplary embodiments of FIGS. 3 and 5 is provided. FIG. 6 illustrates straight end tubes interfacing at various angles with straight spherical end cone snorkels. An end cone design that does not employ spherical end cone snorkels would require a bend in the end tubes, as well as new tooling to accommodate the required bends. The spherical end cone interface that is provided in the present exemplary embodiment illustrated in FIG. 6, however, eliminates the need for a bend in the tube, and, in addition, allows for a more compact design.

As illustrated in FIG. 6, end cone assemblies 302, 304 have respective outer walls 334, 335 that interface at opposed angles with the respective flared openings of the inlet and outlet conduits 306, 308. It should be appreciated that in the present exemplary embodiment, end cone assemblies 302, 304, despite being coaxially aligned on respective ends of housing 300, are able to properly interface with the nonaxially aligned inlet and outlet conduits 306, 308. Moreover, exemplary end cone assemblies 302, 304, despite being connected to respective complimentary ends of housing 300, are configured with respective outer walls 334, 335 that are generally spherical and truncated at respective outlet ends (not shown) to form annular openings that respectively engage generally spherical flares 346, 348 of conduits 306, 308 to form an airtight seal for preventing gas leakage. In other words, while outer walls 334 and 335 are similarly shaped and thus able to use the same tooling during manufacture, the respective openings of outer walls 334 and 335 can be pierced or stamped at respective angles that are offset from the lateral axis 111.

In accordance with exemplary embodiments of the present invention, end cone assemblies, when manufactured using a metal stamping process as described above, can require at most a change in a single die or tool station to adapt a generally spherical wall portion to variations in the angles of the inlet and outlet openings of exhaust pipes. This is because the only variation between embodiments that may be necessary is in the size and/or location of the snorkel's orbicular opening, which, as described above, is formed using a single piercing die at a single piercing station in the metal stamping process. Thus, end cone assemblies constructed in accordance with exemplary embodiments of the present invention can provide the ability to adapt to variations in the angles of the inlet and outlet openings of exhaust pipes while only changing the piercing step of the manufacturing process. As a result, end cones can be configured to connect with different sized or angled exhaust pipes with a change of just a single new die set. This improvement can radically reduce the time and expense of producing end cones of varying sizes, as well as enable a more compact end cone assembly design.

Prior manufacturing processes would require separate tooling for design changes wherein the tooling costs may be on the order of hundreds of thousand dollars. In contrast, in exemplary embodiments of the present invention, the interface between the outer spherical wall portion and the conduit can simply be adjusted to provide various configurations not achievable by the prior processes without prohibitive tooling costs.

Furthermore, by utilizing a spherical wall of an end cone assembly and a flared orbicular opening of an exhaust conduit, many further advantages are achieved by exemplary embodiments of the present invention. First, the spherical outer wall allows the outer surface of either a single wall or a dual wall end cone assembly to be secured to an inner surface of the conduit structure wherein a flared opening of the inner surface of the conduit and the matching spherical outer surface of the outer wall allows the conduit to be arranged at many angles, some of which can be offset from the lateral axis extending through the exhaust treatment device. This can be achieved in exemplary embodiments in a variety of ways, such as by merely relocating the opening in the spherical wall, reducing the diameter of the opening, reducing the diameter of the exhaust conduit, slightly adjusting the location of the conduit, or any combination of the foregoing. Accordingly, the orbicular opening may be located in other locations also offset from the lateral axis.

Moreover, because the spherical geometry of the junction between end cone assemblies and exhaust tubes in exemplary embodiments can be welded over a larger diameter, an increase in joint strength and resistance to bonding fatigue can be provided. More specifically, by securing an exterior surface of the end cone assembly to an interior surface of the exhaust conduit instead of inserting the exhaust conduit into the end cone assembly, the forces of the joint are spread out over a larger weld diameter.

Finally, exemplary embodiments of the present invention utilize an interface between an exterior wall of the spherical member (e.g., single or dual wall) and an inner surface of the conduit to provide the surfaces to be welded together. In contrast, prior end cone assemblies required the insertion of the conduit into an opening of the end cone assembly thus providing an inflexible design that cannot allow various angular offsets to be achieved without incurring the costs of new tooling to achieve the desired design configuration since the exterior surface of the conduit was secured to an inner surface of the end con assembly. Furthermore, in exemplary embodiments of the present invention, axial loads applied during the welding process will not damage the generally spherical wall because the materials of the end cone and the specific configuration of the same allows the areas proximate to the weld to be deflected inwardly, as the exhaust conduit is welded to the exterior surface. Moreover, in accordance with exemplary embodiments of the present invention, this weld interface can be less cumbersome to achieve and more resistant to stresses encountered by the exhaust system.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An interface for connecting a transition pipe of an exhaust producing device to a housing of an exhaust treatment device, comprising:
a generally spherical structure having a truncated first end and a second end, the truncated first end having an orbicular opening; and
a conduit structure having a first end and a second end, the first end of the conduit structure having a generally spherically flared orbicular opening, an inner surface of the conduit structure proximate to the flared orbicular opening of the first end of the conduit structure being secured to an exterior surface of the generally spherical structure proximate to the orbicular opening of the truncated first end to form a fluid passageway through the conduit structure and the generally spherical structure, the truncated first end of the generally spherically structure and the generally spherically flared orbicular opening of the conduit structure each allowing the conduit structure to be angularly offset from a lateral axis through the exhaust treatment device.

2. The interface of claim 1, wherein the conduit structure is secured to the generally spherical structure by a weld and the second end of the generally spherical structure is configured to be secured to the housing of the exhaust treatment device, and the second end of the conduit structure is configured to be secured to the transition pipe.

3. The interface of claim 1, wherein the second end of the generally spherical structure is configured to be secured to an exhaust inlet end of the housing of the exhaust treatment device, and the second end of the conduit structure is configured to be secured an exhaust outlet end of the transition pipe.

4. The interface of claim 1, wherein the second end of the conduit structure is integrally formed with the transition pipe to form a one-piece component.

5. The interface of claim 1, wherein a flex-joint secures the conduit structure to the generally spherical structure and the exhaust treatment device is a catalytic converter.

6. The interface of claim 1, wherein the inner surface of the conduit structure proximate to the flared orbicular opening of the first end is secured to a predetermined nonaxial location on the exterior surface of the generally spherical structure proximate to the orbicular opening of the truncated first end.

7. The interface of claim 1, wherein the orbicular opening of the truncated first end of the generally spherical structure is located at a predetermined nonaxial location of the truncated first end of the generally spherical structure.

8. The interface of claim 1, wherein the orbicular opening of the truncated first end of the generally spherical structure has a predetermined diameter that is angularly offset from the lateral axis.

9. A method for providing interfaces for fluid paths through an exhaust treatment device, the method comprising:
forming a first end cone with a generally spherical wall portion;
forming a second end cone with a generally spherical wall portion, the generally spherical wall portion of the first end cone being substantially similar to the generally spherical wall portion of the second end cone;
providing an orbicular opening in the generally spherical wall of the first end cone, the first end cone having an inlet end, an outlet end, the generally spherical wall being truncated at the inlet end proximate to the orbicular opening;
providing an orbicular opening in the generally spherical wall of the second end cone, the second end cone having an inlet end, an outlet end, the generally spherical wall being truncated at the inlet end proximate to the orbicular opening;
securing an inner surface of a flared opening of a first exhaust conduit to an exterior surface of the generally spherical wall of the first end cone proximate to the orbicular opening to form a first fluid passageway through the first exhaust conduit and the first end cone;
securing an inner surface of a flared opening of a second exhaust conduit to an exterior surface of the generally spherical wall of the second end cone proximate to the orbicular opening to form a second fluid passageway through the second exhaust conduit and the second end cone;
securing the outlet end of the first end cone to one end of a housing of the exhaust treatment device; and
securing the outlet end of the second end cone to another end of the housing.

10. The method as in claim 9, wherein the orbicular opening of the first end cone is positioned at an angle from a lateral axis through the housing and the orbicular opening of the second end cone is positioned at an angle aligned with the lateral axis.

11. The method as in claim 9, wherein the orbicular opening of the first end cone is larger than the orbicular opening of the second end cone.

12. The method as in claim 9, wherein the first end cone further comprises a first inner cone inserted into the first end cone and a portion of the first inner cone being in a facing spaced relationship with respect to an inner surface of the first end cone to define a first insulating area and an insulating material disposed in the first insulating area; and wherein the second end cone further comprises an second inner cone inserted into the second end cone and a portion of the second inner cone being in a facing spaced relationship with respect to an inner surface of the second end cone to define a second insulating area and an insulating material disposed in the second insulating area.

13. The method as in claim 12, wherein the orbicular opening of the first end cone is positioned at an angle from a lateral axis through the housing and the orbicular opening of the second end cone is positioned at an angle from the lateral axis.

14. The method as in claim 12, wherein the orbicular opening of the first end cone is larger than the orbicular opening of the second end cone.

15. A method for providing an interface between a housing of an exhaust treatment device and a conduit, the method comprising:
forming a first end cone with a generally spherical wall;
providing an orbicular opening in the generally spherical wall;
securing an inner surface of a flared opening of the conduit to an exterior surface of the generally spherical wall proximate to the orbicular opening to provide the interface, the configuration of the generally spherical wall allowing the interface to be at numerous locations without requiring a change in the curvature of the generally spherical wall.

16. An exhaust assembly for directing a flow of exhaust emissions from an exhaust producing device through an exhaust treatment device, the exhaust assembly comprising:
an exhaust pipe having an inner surface, an inlet end, and an outlet end having a flared orbicular opening;
an end cone assembly having a cone inlet end, a cone outlet end, and a generally spherical wall truncated at the cone inlet end to form an orbicular opening, an exterior surface of the generally spherical wall proximate to the orbicular opening at the cone inlet end being secured to the inner surface of the exhaust pipe proximate to the flared orbicular opening of the pipe outlet end to form a fluid passageway through the exhaust pipe and the end cone assembly, the truncated end of the generally spherically wall and the flared orbicular opening of the exhaust pipe each allowing the exhaust pipe to be angularly offset from a lateral axis extending through the exhaust treatment device; and
a housing of the exhaust treatment device having an inlet end connected secured to the cone outlet end of the end cone assembly.

17. The exhaust assembly of claim 16, wherein the end cone assembly is integrally formed with the housing as a one-piece component and the end cone assembly further comprises a conical intermediate wall, the conical intermediate wall being disposed between the generally spherical wall and the housing of the exhaust treatment device.

18. The exhaust assembly of claim 16, wherein the generally spherical wall and the conical intermediate wall further comprise a sheet metal outer layer and a formed sheet metal inner layer forming a dual layer assembly, a periphery of the outer layer being larger than the inner layer, the inner and outer layers being in a spaced relation to one another at the generally conical intermediate wall to form an insulating space therebetween, the inner and outer layers engaging one another at the generally spherical wall and an insulating material disposed in the insulating space.

19. An end cone assembly for coupling a conduit structure to an exhaust treatment device, comprising:
an inner wall having a first end and a second end;
an outer wall having a first end and a second end, the first end of the outer wall being coupled to the inner wall proximate to the first end of the inner wall, an outer surface of the outer wall proximate the first end of the outer wall is of a generally arcuate shape to engage an interior surface of a flared wall of the conduit structure to define a fluid flow path through the conduit structure and the end cone assembly, the second end of the outer wall being configured to engage a housing of the exhaust treatment device, the second end of the outer wall being spaced away from the second end of the inner wall so as to define an inner region therebetween; and
an insulating layer disposed within the inner region between a portion of the outer wall and a portion of the inner wall, the generally arcuate shape of the first end of the outer wall and the interior surface of the flared wall of the conduit structure allows the conduit structure to be angularly offset from a lateral axis extending through the exhaust treatment device.

20. The end cone assembly of claim 19, wherein the exhaust treatment device is a catalytic converter, the housing having an inlet end and an outlet end and the end cone assembly is secured to either the inlet end or the outlet end of the housing and the fluid path is partially defined by an opening in the outer wall that is angularly offset from the lateral axis.
